(19) United States
(12) Patent Application Publication
(10) Pub. No.: US 2025/0238240 A1
(43) Pub. Date: Jul. 24, 2025

(54) DATA PROCESSING SYSTEM WITH MONITORING OF DRIVER SETTING PROGRAMMING STATUSES AND ASSOCIATED DATA PROCESSING METHOD

(71) Applicant: MEDIATEK INC., Hsinchu City (TW)

(72) Inventors: Chia-Han Huang, Hsinchu City (TW); Huei-Min Lin, Hsinchu City (TW)

(73) Assignee: MEDIATEK INC., Hsinchu City (TW)

(21) Appl. No.: 19/008,647

(22) Filed: Jan. 3, 2025

Related U.S. Application Data
(60) Provisional application No. 63/623,834, filed on Jan. 23, 2024.

(51) Int. Cl. G06F 9/4401; G06F 11/34

(52) U.S. Cl. CPC G06F 9/4411; G06F 11/3485

(57) ABSTRACT

A data processing system includes a source device, a first processing device, and a first monitoring circuit. The source device generates a streaming output, where the streaming output includes consecutive data segments for each data path, and the consecutive data segments are output during consecutive periods, respectively. The first processing device is located on at least one data path, and receives and processes a first streaming input derived from the streaming output. When a monitor result generated from the first monitoring circuit indicates that driver settings of the source device are not ready before a start time of a first period or driver settings of the first processing device are not ready before the start time of the first period, the first processing device is configured to skip processing of streaming data associated with at least one period starting from the first period.

### CROSS REFERENCE TO RELATED APPLICATIONS

This application claims the benefit of U.S. Provisional Application No. 63/623,834, filed on Jan. 23, 2024. The content of the application is incorporated herein by reference.

### BACKGROUND

The present invention relates to processing a data stream generated from a source device, and more particularly, to a data processing system with monitoring of driver setting programming statuses and an associated data processing method.

In an image processing system, image data can flow from a source device to multiple processing components. For example, the source device may include one or more image sensors, and a processing component may be a hardware circuit or a software program that does the image processing or data transmission on one of a variety of data types, including image data with different exposure time, phase difference (PD) data, embedded (EMB) data, etc. For an image path that contains multiple processing components, the software drivers (or hardware drivers) need to update the configurations of the source device and/or processing components on the path when driver settings change, where the driver settings may include camera parameters, algorithm parameters, memory addresses, etc. The update progress should be in-time and without source on/off flows for efficiency. That is, programming of driver settings of the source device and/or processing components should be performed under a condition that the source device does not pause the image data streaming. However, the configuration flow for a new frame may not finish when the new frame starts streaming if the programming time is too long and/or the programming start time is too late. Because a source sensor cannot hold data while streaming, the new frame will be applied with incomplete settings in this situation. Besides, processing components on different parallel branches may have configuration racing among one another. If the settings among all branches are not synchronous, the mismatch leads to wrong data processing results. Thus, there is a need for an innovative design which is capable of preventing a frame from being applied with incomplete or mismatched settings.

### SUMMARY

One of the objectives of the claimed invention is to provide a data processing system with monitoring of driver setting programming statuses and an associated data processing method. For example, the proposed data processing system and data processing method may be employed by an image processing application.

According to a first aspect of the present invention, an exemplary data processing system is disclosed. The exemplary data processing system includes a source device, a first processing device, and a first monitoring circuit. The source device is configured to generate a streaming output, wherein the streaming output comprises consecutive data segments for each data path, and the consecutive data segments are output during consecutive periods, respectively. The first processing device is located on at least one data path, and configured to receive and process a first streaming input derived from the streaming output. The first monitoring circuit is configured to monitor if driver settings of the source device are ready before a start time of a first period included in the consecutive periods, and further monitor if driver settings of the first processing device are ready before the start time of the first period. When a monitor result generated from the first monitoring circuit indicates that the driver settings of the source device are not ready before the start time of the first period or the driver settings of the first processing device are not ready before the start time of the first period, the first processing device is configured to skip processing of streaming data associated with at least one period starting from the first period.

According to a second aspect of the present invention, an exemplary data processing method is disclosed. The exemplary data processing method includes: generating, by a source device, a streaming output that comprises consecutive data segments for each data path, wherein the consecutive data segments are output during consecutive periods, respectively; receiving and processing, by a first processing device located on at least one data path, a first streaming input that is derived from the streaming output; monitoring if driver settings of the source device are ready before a start time of a first period included in the consecutive periods; monitoring if driver settings of the first processing device are ready before the start time of the first period; and in response to a monitor result indicating that the driver settings of the source device are not ready before the start time of the first period or the driver settings of the first processing device are not ready before the start time of the first period, skipping processing of streaming data associated with at least one period starting from the first period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a data processing system according to an embodiment of the present invention.

FIG. 2 is a diagram illustrating a first image processing system with monitoring of driver setting programming statuses according to an embodiment of the present invention.

FIG. 3 is a diagram illustrating a second image processing system with monitoring of driver setting programming statuses according to an embodiment of the present invention.

FIG. 4 is a diagram illustrating a third image processing system with monitoring of driver setting programming statuses according to an embodiment of the present invention.

FIG. 5 is a diagram illustrating a fourth image processing system with monitoring of driver setting programming statuses according to an embodiment of the present invention.

FIG. 6 is a diagram illustrating a first monitor behavior according to an embodiment of the present invention.

FIG. 7 is a diagram illustrating a second monitor behavior according to an embodiment of the present invention.

FIG. 8 is a diagram illustrating a third monitor behavior according to an embodiment of the present invention.

FIG. 9 is a diagram illustrating a grouping logic design according to an embodiment of the present invention.

FIG. 10 is a diagram illustrating a no-grouping case according to an embodiment of the present invention.

FIG. 11 is a diagram illustrating a single-group case according to an embodiment of the present invention.

FIG. 12 is a diagram illustrating a hybrid case according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

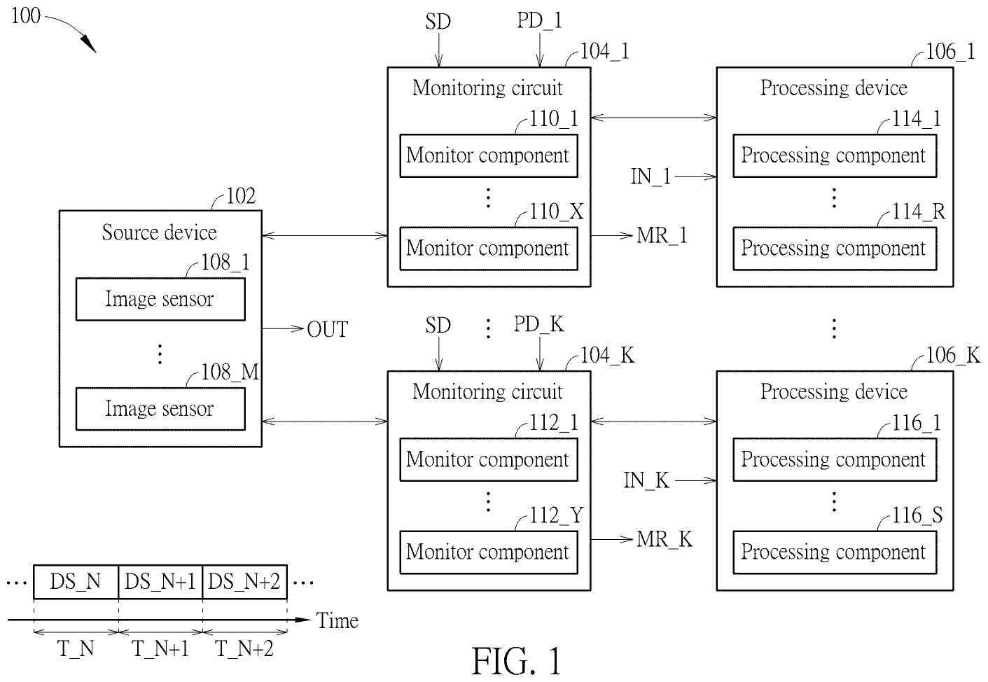

FIG. 1 is a diagram illustrating a data processing system according to an embodiment of the present invention. The data processing system 100 includes a source device 102, one or more monitoring circuits 104_1-104_K (K≥1), and one or more processing devices 106_1-106_K (K≥1). The source device 102 is configured to generate a streaming output OUT, where the streaming output OUT includes consecutive data segments (e.g., DS_N, DS_N+1, and DS_N+2) for each data path, and the consecutive data segments (e.g., DS_N, DS_N+1, and DS_N+2) are output during consecutive periods (e.g., T_N, T_N+1, and T_N+2), respectively. Each of the processing devices 106_1-106_K (K≥1) is located on at least one data path. The processing devices 106_1-106_K (K≥1) are configured to receive and process streaming inputs IN_1-IN_K (K≥1) derived from the streaming output OUT, respectively. The monitoring circuits 104_1-104_K (K≥1) correspond to the processing device 106_1-106_K (K≥1), respectively. Each of the monitoring circuits 104_1-104_K (K≥1) is configured to monitor if driver settings of the source device 102 are ready before a start time of a period (e.g., periodT_N+1) in which a new data segment (e.g., DS_N+1) is going to be streamed in (i.e., a streaming start time of the new data segment), and further monitor if driver settings of a corresponding processing device are ready before the start time of the period (e.g., T_N+1). For example, the monitoring circuit 104_1 monitors if driver settings of the source device 102 are ready before the start time of the period (e.g., T_N+1) according to a driver setting programming status SD of the source device 102, and further monitors if driver settings of the processing device 106_1 are ready before the start time of the period (e.g., T_N+1) according to a driver setting programming status PD_1 of the processing device 106_1. Similarly, the monitoring circuit 104_K monitors if driver settings of the source device 102 are ready before the start time of the period (e.g., T_N+1) according to the driver setting programming status SD of the source device 102, and further monitors if driver settings of the processing device 106_K are ready before the start time of the period (e.g., T_N+1) according to a driver setting programming status PD K of the processing device 106_K.

For example, when programming of driver settings is not completed before the start time of the period (e.g., T_N+1), it is determined that the driver settings are not ready yet. For another example, when current driver settings do not match desired driver settings before the start time of the period (e.g., T_N+1), it is determined that the driver settings are not ready yet.

When a monitor result MR_1 generated from the monitoring circuit 104_1 indicates that the driver settings of the source device 102 are ready before the start time of the period (e.g., T_N+1) and the driver settings of the processing device 106_1 are ready before the start time of the period (e.g., T_N+1), the processing device 106_1 is allowed to perform processing of streaming data (e.g., data segment DS_N+1) associated with the period (e.g., T_N+1). However, when the monitor result MR_1 generated from the monitoring circuit 104_1 indicates that the driver settings of the source device 102 are not ready before the start time of the period (e.g., T_N+1) or the driver settings of the processing device 106_1 are not ready before the start time of the period (e.g., T_N+1), the processing device 106_1 is configured to skip processing of streaming data associated with at least one period starting from the period (e.g., T_N+1). For example, when the driver settings are not ready, the processing device 106_1 does not need to perform processing of streaming data (e.g., data segment DS_N+1) associated with the period (e.g., T_N+1). For another example, when the driver settings are not ready, the processing device 106_1 does not need to perform processing of streaming data (e.g., data segment DS_N+1) associated with the period (e.g., T_N+1) and processing of streaming data (e.g., data segment DS_N+2) associated with the following period (e.g., T_N+2), where the data segment DS_N+2 may be paired with the data segment DS_N+1, and may also be dropped when the data segment DS_N+1 is dropped due to incomplete or mismatched driver settings.

Similarly, when a monitor result MR_K generated from the monitoring circuit 104_K indicates that the driver settings of the source device 102 are ready before the start time of the period (e.g., T_N+1) and the driver settings of the processing device 106_K are ready before the start time of the period (e.g., T_N+1), the processing device 106_K is allowed to perform processing of streaming data (e.g., data segment DS_N+1) associated with the period (e.g., T_N+1). However, when the monitor result MR_K generated from the monitoring circuit 104_K indicates that the driver settings of the source device 102 are not ready before the start time of the period (e.g., T_N+1) or the driver settings of the processing device 106_K are not ready before the start time of the period (e.g., T_N+1), the processing device 106_K is configured to skip processing of streaming data associated with at least one period starting from the period (e.g., T_N+1). For example, when the driver settings are not ready, the processing device 106_K does not need to perform processing of streaming data (e.g., data segment DS_N+1) associated with the period (e.g., T_N+1). For another example, when the driver settings are not ready, the processing device 106_K does not need to perform processing of streaming data (e.g., data segment DS_N+1) associated with the period (e.g., T_N+1) and processing of streaming data (e.g., data segment DS_N+2) associated with the following period (e.g., T_N+2), where the data segment DS_N+2 may be paired with the data segment DS_N+1, and may also be dropped when the data segment DS_N+1 is dropped due to incomplete or mismatched driver settings.

In some embodiments of the present invention, the data processing system 100 may be employed by an image processing application. For better comprehension of technical features of the present invention, the following assumes that the data processing system 100 acts as an image processing system. As shown in FIG. 1, the source device 102 may include one or more image sensors 108_1-108_M (M≥1), the monitoring circuit 104_1 may include one or more monitor components 110_1-110_X (X≥1), the monitoring circuit 104_K may include one or more monitor components 110_1-110_Y (Y≥1), the processing device 106_1 may include one or more processing components (e.g., image signal processing pipeline components) 114_1-114_R (R≥1) each located on one data path, and the processing device 106_K may include one or more processing components (e.g., image signal processing pipeline components) 116_1-116_S (S≥1) each located on one data path, where X may be equal to or different from Y, R may be the equal to or different from S, R may be equal to or smaller than X, and S may be equal to or smaller than Y. The processing components 114_1-114_R and 116_1-116_S are located on different data paths, respectively. In addition, the consecutive data segments (e.g., DS_N, DS_N+1, DS_N+2) on each data path may be image frames.

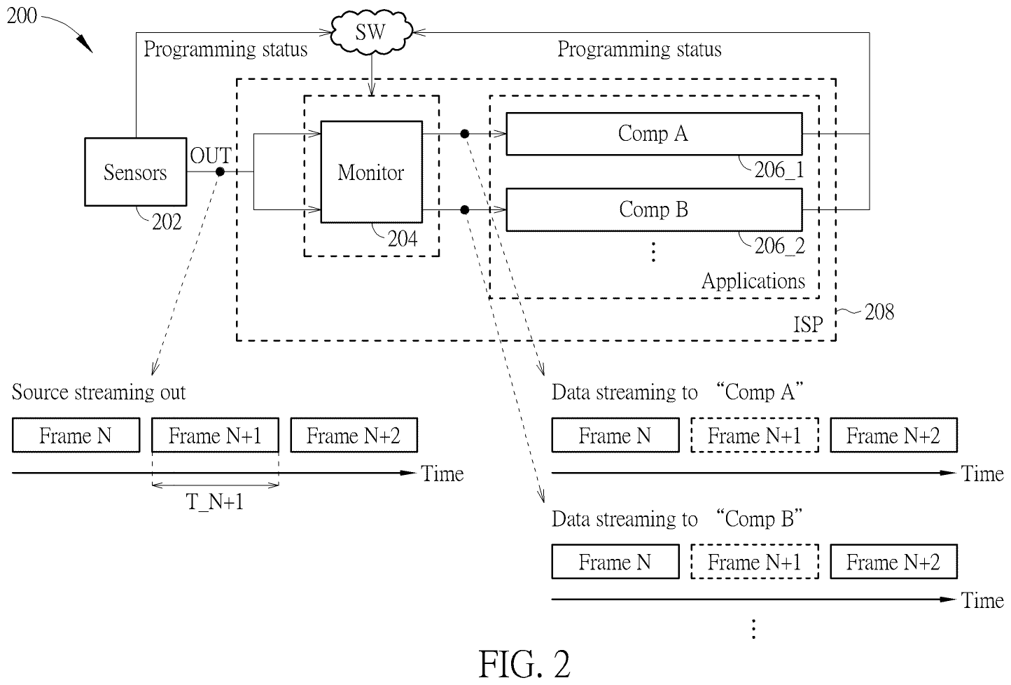

FIG. 2 is a diagram illustrating a first image processing system with monitoring of driver setting programming statuses according to an embodiment of the present invention. The design of the image processing system 200 is based on the data processing system 100, and includes a source device (labeled by “Sensors”) 202, a monitor component (labeled by “Monitor”) 204, and a plurality of processing components (labeled by “Comp A” and “Comp B”) 206_1, 206_2. Specifically, the data processing system 100 has the source device 102 implemented by the source device 202, the monitor component 110_1 (X=1) of the monitoring circuit 104_1 (K=1) implemented by the monitor component 204, and the processing components 114_1, 114_R (R=2) of the processing device 106_1 (K=1) implemented by the processing components 206_1, 206_2. In this example, the monitor component 204 and the processing components 206_1, 206_2 may be implemented in an image signal processor (ISP) 208. In addition, the software drivers (labeled by “SW”) are responsible for programming driver settings of the source device 202 and the processing components 206_1, 206_2, and may be used to inform the monitor component 204 of a driver setting programming status of the source device 202 and a driver setting programming status of each of the processing components 206_1, 206_2. When a monitor result generated from the monitor component 204 indicates that driver settings of the source device 202 are not ready before a start time of a period T_N+1 or driver settings of any of the processing components 206_1, 206_2 are not ready before the start time of the period T_N+1, each of the processing components 206_1, 206_2 skips processing of streaming data associated with the period T_N+1. In this embodiment, the monitor component 202 is coupled between the source device 202 and the processing components 206_1, 206_2. When the monitor result generated from the monitor component 204 indicates that driver settings of the source device 202 are not ready before the start time of the period T_N+1 or driver settings of any of the processing components 206_1, 206_2 are not ready before the start time of the period T_N+1, the monitor component 202 drops a frame N+1 received from the source device 202 during the period T_N+1. Since a frame N+1 to be streamed to the following processing component 206_1 is dropped by the monitor component 204, the processing component 206_1 does not receive the frame N+1, and therefore achieves the objective of skipping processing of the frame N+1 associated with the period T_N+1. Similarly, since a frame N+1 to be streamed to the following processing component 206_2 is dropped by the monitor component 202, the processing component 206_2 does not receive the frame N+1, and therefore achieves the objective of skipping processing of the frame N+1 associated with the period T_N+1. It should be noted that the frame N+1 to be streamed to the processing component 206_1 may be the same as the frame N+1 to be streamed to the processing component 206_2, or may be different from the frame N+1 to be streamed to the processing component 206_2.

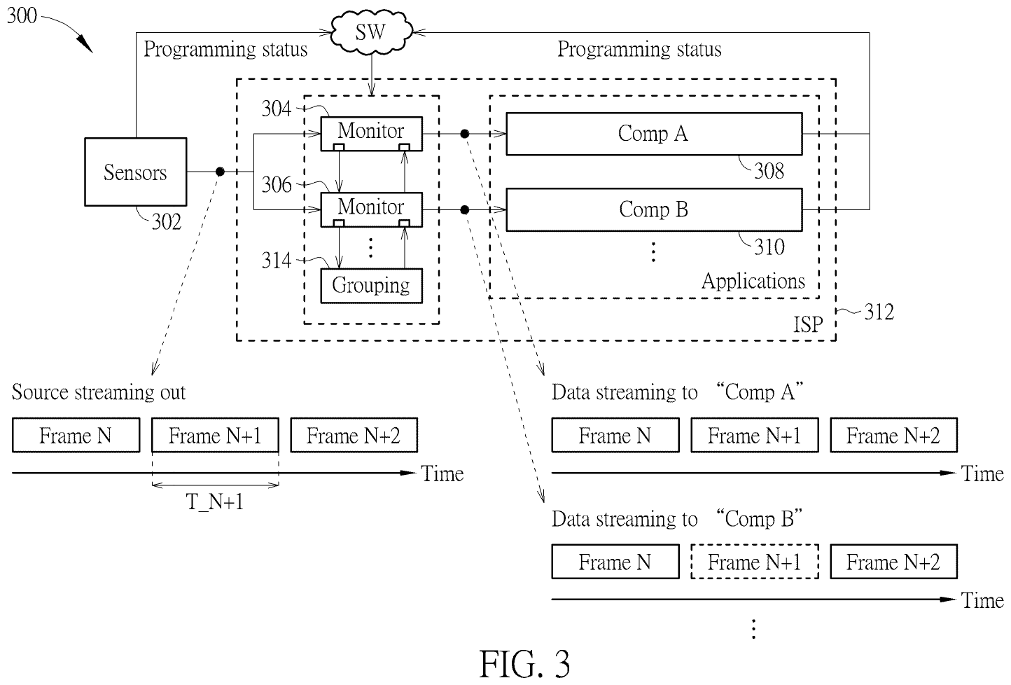

FIG. 3 is a diagram illustrating a second image processing system with monitoring of driver setting programming statuses according to an embodiment of the present invention. The design of the image processing system 300 is based on the data processing system 100, and includes a source device (labeled by “Sensors”) 302, a plurality of monitor component (labeled by “Monitor”) 304, 306, and a plurality of processing components (labeled by “Comp A” and “Comp B”) 308, 310. Specifically, the data processing system 100 has the source device 102 implemented by the source device 302, the monitor component 110_1 (X=1) of the monitoring circuit 104_1 implemented by the monitor component 304, the monitor component 112_1 (Y=1) of the monitoring circuit 104_K (K=2) implemented by the monitor component 304, the processing components 114_1 (R=1) of the processing device 106_1 implemented by the processing component 308, and the processing components 116_1 (S=1) of the processing device 106_K (K=2) implemented by the processing component 310. In this example, the monitor components 304, 306 and the processing components 308, 310 may be implemented in an ISP 312. In addition, the software drivers (labeled by “SW”) are responsible for programming driver settings of the source device 302 and the processing components 308, 310. The software drivers may be used to inform the monitor component 304 of a driver setting programming status of the source device 302 and a driver setting programming status of the processing component 308, and further inform the monitor component 306 of the driver setting programming status of the source device 302 and a driver setting programming status of the processing component 310. When a monitor result generated from the monitor component 304 indicates that driver settings of the source device 302 are ready before a start time of a period T_N+1 and driver settings of the processing component 308 are ready before the start time of the period T_N+1, the processing component 308 is allowed to perform processing of streaming data (e.g., frame N+1) associated with the period T_N+1. When a monitor result generated from the monitor component 306 indicates that driver settings of the source device 302 are not ready before the start time of the period T_N+1 or driver settings of the processing component 310 are not ready before the start time of the period T_N+1, the processing component 310 skips processing of streaming data (e.g., frame N+1) associated with the period T_N+1. In this embodiment, the monitor component 304 is coupled between the source device 302 and the processing component 308, and the monitor component 306 is coupled between the source device 302 and the processing component 310. When the monitor result generated from the monitor component 306 indicates that driver settings of the source device 302 are not ready before the start time of the period T_N+1 or driver settings of the processing component 310 are not ready before the start time of the period T_N+1, the monitor component 306 drops the frame N+1 received from the source device 302 during the period T_N+1. Since the frame N+1 to be streamed to the processing component 310 is dropped by the monitor component 306, the processing component 310 does not receive the frame N+1, and therefore achieves the objective of skipping processing of the frame N+1 associated with the period T_N+1. It should be noted that the frame N+1 to be streamed to the processing component 308 may be the same as the frame N+1 to be streamed to the processing component 310, or may be different from the frame N+1 to be streamed to the processing component 310.

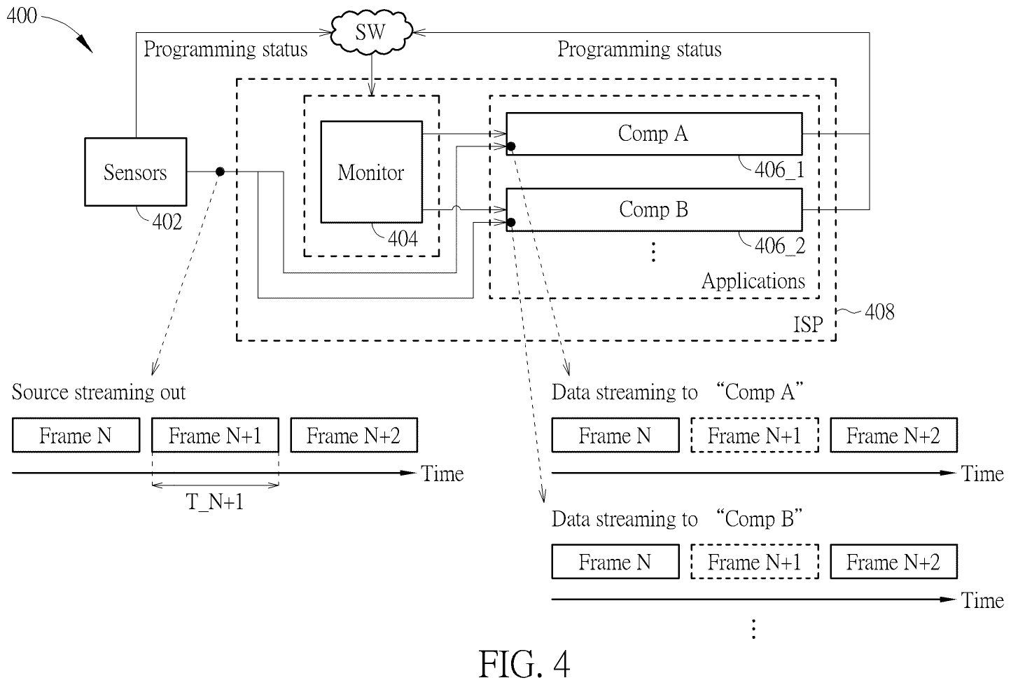

FIG. 4 is a diagram illustrating a third image processing system with monitoring of driver setting programming statuses according to an embodiment of the present invention. The design of the image processing system 400 is based on the data processing system 100, and includes a source device (labeled by “Sensors”) 402, a monitor component (labeled by “Monitor”) 404, and a plurality of processing components (labeled by “Comp A” and “Comp B”) 406_1, 406_2. Specifically, the data processing system 100 has the source device 102 implemented by the source device 402, the monitor component 110_1 (X=1) of the monitoring circuit 104_1 (K=1) implemented by the monitor component 404, and the processing components 114_1, 114_R (R=2) of the processing device 106_1 (K=1) implemented by the processing components 406_1, 406_2. In this example, the monitor component 404 and the processing components 406_1, 406_2 may be implemented in an ISP 408. In addition, the software drivers (labeled by “SW”) are responsible for programming driver settings of the source device 402 and the processing components 406_1, 406_2, and may be used to inform the monitor component 404 of a driver setting programming status of the source device 402 and a driver setting programming status of each of the processing components 406_1, 406_2. When a monitor result generated from the monitor component 404 indicates that driver settings of the source device 402 are not ready before a start time of a period T_N+1 or driver settings of any of the processing components 406_1, 406_2 are not ready before the start time of the period T_N+1, each of the processing components 406_1, 406_2 skips processing of streaming data associated with the period T_N+1. In this embodiment, the source device 402 is coupled to the processing components 406_1, 406_2 without via the monitor component 404. When the monitor result generated from the monitor component 404 indicates that driver settings of the source device 402 are not ready before the start time of the period T_N+1 or driver settings of any of the processing components 406_1, 406_2 are not ready before the start time of the period T_N+1, the monitor component 404 instructs the processing component 406_1 to drop a frame N+1 received from the source device 402 during the period T_N+1. Since the frame N+1 received by the processing component 406_1 is dropped before being processed by the processing component 406_1, the objective of skipping processing of the frame N+1 associated with the period T_N+1 is achieved by frame dropping at the processing component 406_1.

Similarly, when a monitor result generated from the monitor component 404 indicates that driver settings of the source device 402 are not ready before the start time of the period T_N+1 or driver settings of any of the processing components 406_1, 406_2 are not ready before the start time of the period T_N+1, the monitor component 404 also instructs the processing component 406_2 to drop a frame N+1 received from the source device 402 during the period T_N+1. Since the frame N+1 is dropped before the processing component 406_2 receives and processes it, the frame N+1 is not handled by the processing component 406_2. The objective of skipping processing of the frame N+1 associated with the period T_N+1 is achieved by frame dropping at the processing component 406_2. It should be noted that the frame N+1 to be streamed to the processing component 406_1 may be the same as the frame N+1 to be streamed to the processing component 406_2, or may be different from the frame N+1 to be streamed to the processing component 406_2.

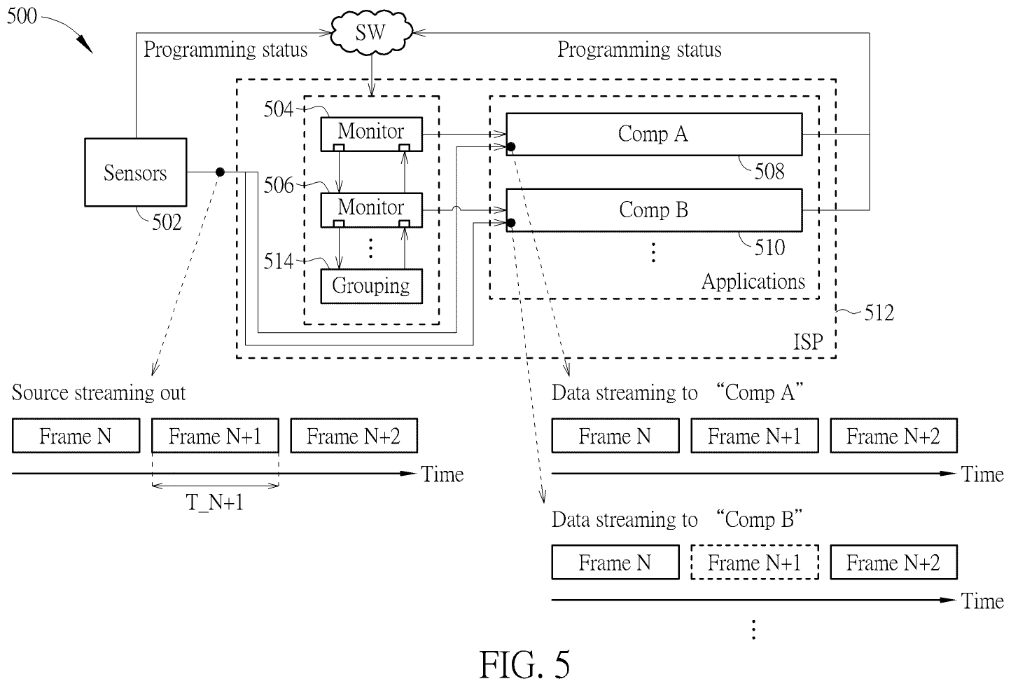

FIG. 5 is a diagram illustrating a fourth image processing system with monitoring of driver setting programming statuses according to an embodiment of the present invention. The design of the image processing system 500 is based on the data processing system 100, and includes a source device (labeled by “Sensors”) 502, a plurality of monitor component (labeled by “Monitor”) 504, 506, and a plurality of processing components (labeled by “Comp A” and “Comp B”) 508, 510. Specifically, the data processing system 100 has the source device 102 implemented by the source device 502, the monitor component 110_1 (X=1) of the monitoring circuit 104_1 implemented by the monitor component 504, the monitor component 112_1 (Y=1) of the monitoring circuit 104_K (K=2) implemented by the monitor component 506, the processing components 114_1 (R=1) of the processing device 106_1 implemented by the processing component 508, and the processing components 116_1 (S=1) of the processing device 106_K (K=2) implemented by the processing component 510. In this example, the monitor components 504, 506 and the processing components 508, 510 may be implemented in an ISP 512. In addition, the software drivers (labeled by “SW”)) are responsible for programming driver settings of the source device 502 and the processing components 508, 510. The software drivers may be used to inform the monitor component 504 of a driver setting programming status of the source device 502 and a driver setting programming status of the processing component 508, and further inform the monitor component 506 of the driver setting programming status of the source device 502 and a driver setting programming status of the processing component 510. When a monitor result generated from the monitor component 504 indicates that driver settings of the source device 502 are ready before a start time of a period T_N+1 and driver settings of the processing component 508 are ready before the start time of the period T_N+1, the processing component 508 is allowed to perform processing of streaming data (e.g., frame N+1) associated with the period T_N+1. When a monitor result generated from the monitor component 506 indicates that driver settings of the source device 502 are not ready before the start time of the period T_N+1 or driver settings of the processing component 510 are not ready before the start time of the period T_N+1, the processing component 510 skips processing of streaming data (e.g., frame N+1) associated with the period T_N+1. In this embodiment, the source device 502 is coupled to the processing component 508 without via the monitor component 504, and the source device 502 is coupled to the processing component 510 without via the monitor component 506. When a monitor result generated from the monitor component 506 indicates that driver settings of the source device 502 are not ready before the start time of the period T_N+1 or driver settings of the processing component 510 are not ready before the start time of the period T_N+1, the monitor component 506 instructs the processing component 510 to drop a frame N+1 received from the source device 502 during the period T_N+1. Since the frame N+1 is dropped before the processing component 510 receives and processes it, the frame N+1 is not handled by the processing component 510. The objective of skipping processing of the frame N+1 associated with the period T_N+1 is achieved by frame dropping at the processing component 510. It should be noted that the frame N+1 to be streamed to the processing component 508 may be the same as the frame N+1 to be streamed to the processing component 510, or may be different from the frame N+1 to be streamed to the processing component 510.

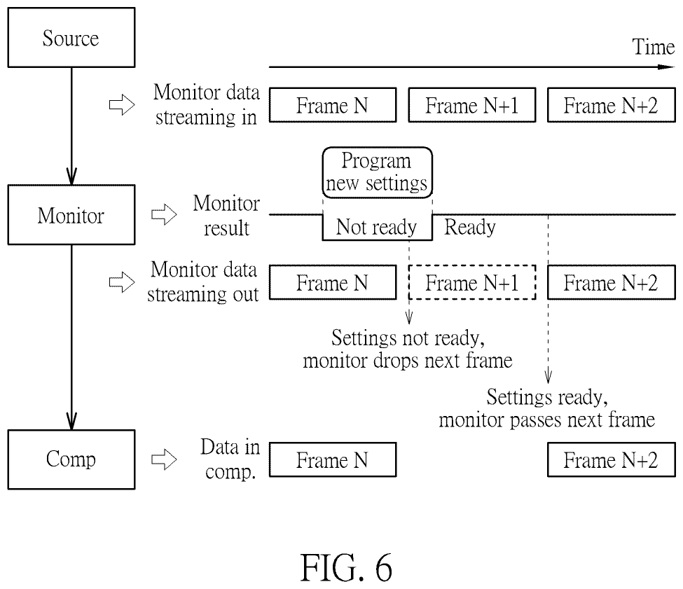

Briefly summarized, when a new frame (which is generated from a source device) streams in and a monitoring circuit (which may include one or more monitor components) observes that driver settings are not ready yet (e.g., programming of new driver settings is still in progress), the monitoring circuit may drop the frame so that no data with incorrect settings will be transmitted from a processing circuit (which may include one or more processing components), as shown in FIG. 6.

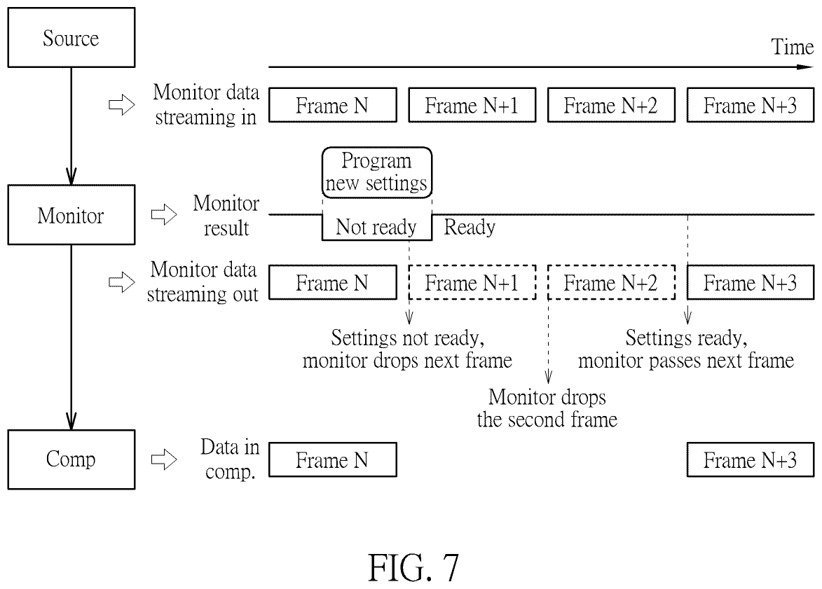

The number of dropped frames may be equal to or larger than 1. As shown in FIG. 7, the frame N+1 is paired with the frame N+2. When a monitor result generated from the monitoring circuit (which may include one or more monitor components) indicates that the driver settings of the source device are not ready before the start time of the frame N+1 or the driver settings of the processing device (which may include one or more processing components) are not ready before the start time of the frame N+1 (e.g., programming of new driver settings is still in progress), the monitoring circuit may drop at least two consecutive frames including a pair of frame N+1 and frame N+2.

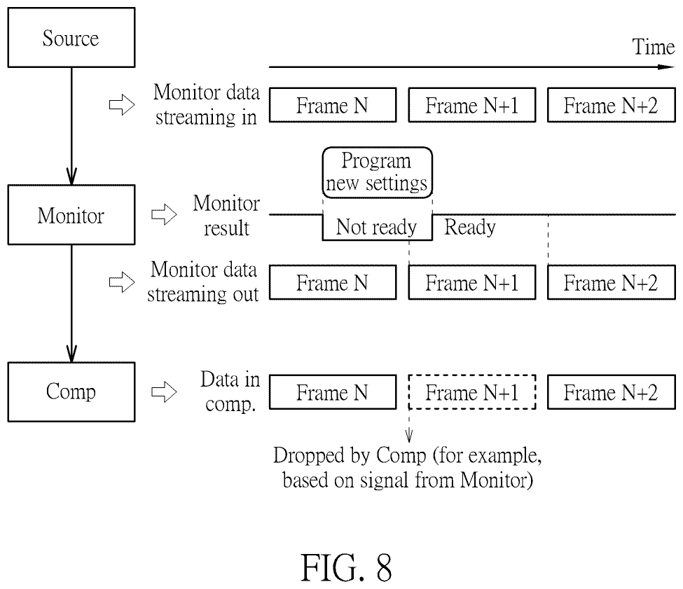

In an alternative design, frame(s) are not dropped by the monitoring circuit (which may include one or more monitor components). As shown in FIG. 8, when a monitor result generated from the monitoring circuit (which may include one or more monitor components) indicates that the driver settings of the source device are not ready before the start time of the frame N+1 or the driver settings of the processing device (which may include one or more processing components) are not ready before the start time of the frame N+1 (e.g., programming of new driver settings is still in progress), the monitoring circuit may send a signal to instruct the processing device to drop the frame N+1 received by the processing device. In some embodiments, the frame N+1 is paired with the frame N+2. When a monitor result generated from the monitoring circuit (which may include one or more monitor components) indicates that the driver settings of the source device are not ready before the start time of the frame N+1 or the driver settings of the processing device (which may include one or more processing components) are not ready before the start time of the frame N+1, the monitoring circuit may send a signal to instruct the processing device to drop at least two consecutive frames including a pair of frame N+1 and frame N+2 received by the processing device.

In some embodiments of the present invention, when multiple processing components are assigned to an image sensor with different branches, each branch may have a monitor component on its path. There may be a grouping function to group monitor results on multiple paths to generate a global monitor result. With the aid of the grouping function, a racing issue resulting from different programming time of updating driver settings of processing components located on different branches can be addressed. Specifically, the global monitor result is jointly determined by multiple monitor components grouped into the same group. The global monitor result indicates that driver settings are ready only when all monitor components in the same group observe that new driver settings are ready. A new frame can pass through all branches in the group (or received by all processing components in the same group) when the global monitor result indicates that driver settings are ready. The global monitor result indicates that driver settings are not ready when any monitor component in the same group observes that new driver settings are not ready. A new frame is dropped at all branches in the group (or dropped by all processing components in the same group) when the global monitor result indicates that driver settings are not ready. In this invention, there can be one or multiple groups, and the assignment of monitor components (or processing components) to groups can be configurable or non-configurable, depending upon actual design considerations.

Regarding the embodiment shown in FIG. 3, one dedicated monitor component 304 is allocated for the processing component 308, and one dedicated monitor component 306 is allocated for the processing component 310, where the monitor components 304, 306 are not assigned to any group. In another embodiment, the grouping function may be implemented by a grouping logic 314 that is configured to combine monitor results of different monitor components (e.g., monitor components 304 and 306) to generate a global monitor result for controlling monitor-side dropping (or component-side dropping) of at least one frame for both of the processing components 308 and 310. Hence, the global monitor result is jointly determined by the monitor components 304 and 306 to control whether both of the processing components 308 and 310 should skip processing of the frame N+1.

Regarding the embodiment shown in FIG. 5, one dedicated monitor component 504 is allocated for the processing component 508, and one dedicated monitor component 506 is allocated for the processing component 510, where the monitor components 504, 506 are not assigned to any group. In another embodiment, the grouping function may be implemented by a grouping logic 514 that is configured to combine monitor results of different monitor components (e.g., monitor components 504 and 506) to generate a global monitor result for controlling monitor-side dropping (or component-side dropping) of at least one frame for both of the processing components 508 and 510. Hence, the global monitor result is jointly determined by the monitor components 504 and 506 to control whether both of the processing components 508 and 510 should skip processing of the frame N+1.

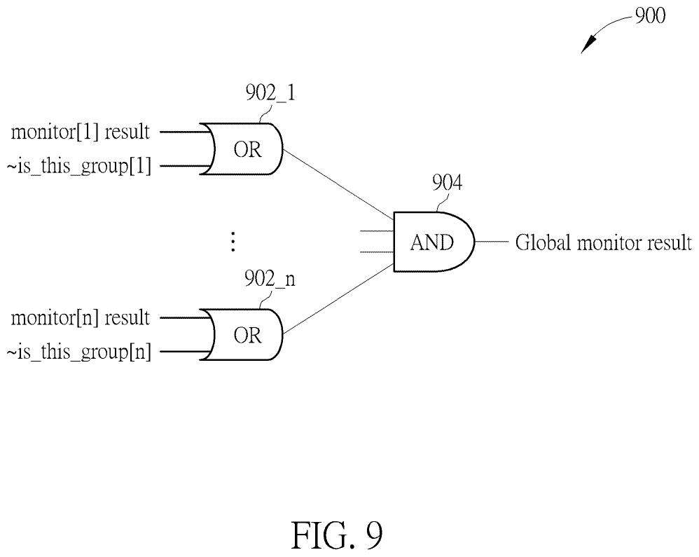

FIG. 9 is a diagram illustrating a grouping logic design according to an embodiment of the present invention. The grouping logic 314/514 may be implemented using the grouping logic 900. As shown in FIG. 9, the grouping logic 900 includes a plurality of OR gates 902_1-902_n and an AND gate 904, where the value of n may depend on the number of monitor components that support the proposed grouping function. Each of the OR gates 902_1-902_n receives a monitor result from a monitor component and an inverse of an is this group flag of the monitor component. The is this group flag is set by a logic high level “1” if the monitor result from the monitor component is involved in setting the global monitor result, and is set by a logic low level “0” if the monitor result from the monitor component is not involved in setting the global monitor result. In addition, the monitor result from the monitor component is set by a logic low level “0” if the driver settings are not ready, and is set by a logic high level “1” if the driver settings are ready. It should be noted that the grouping logic design shown in FIG. 9 is for illustrative purposes only, and is not meant to be a limitation of the present invention. In practice, any means capable of setting the global monitor result by jointly considering monitor results of multiple monitor components in the same group can be adopted.

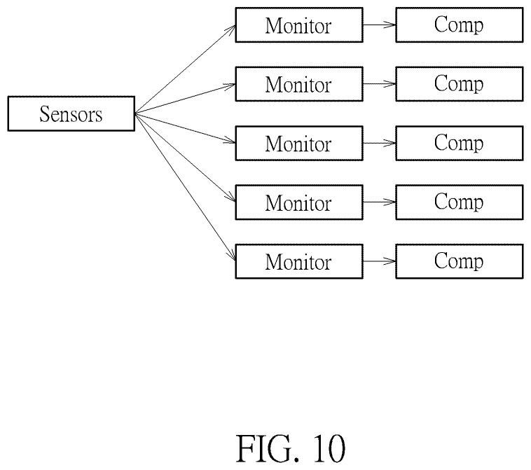

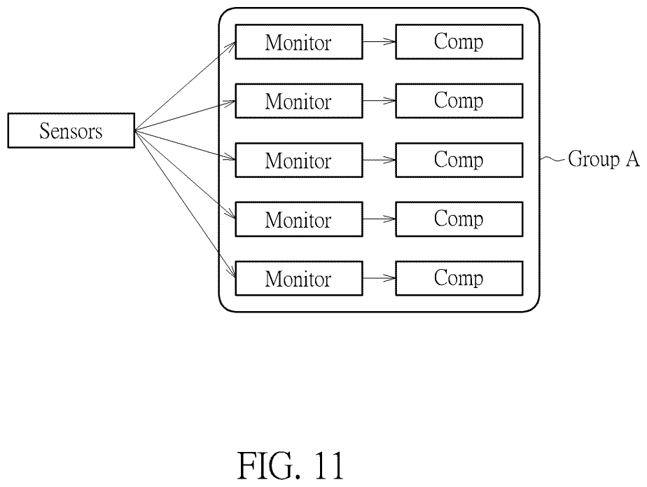

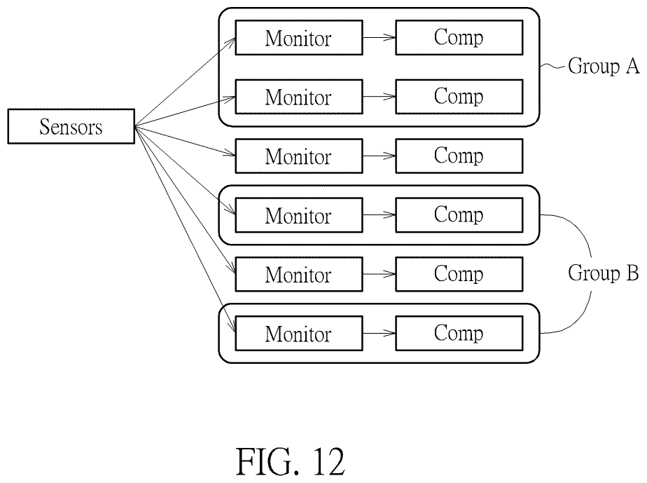

When the data processing system (e.g., image processing system) 100 has a plurality of monitor components dedicated to a plurality of processing components (e.g., image signal processing pipeline components), respectively, the monitor components may be assigned to different groups or may not be assigned to any group, depending upon actual design considerations. FIG. 10 is a diagram illustrating a no-grouping case according to an embodiment of the present invention, where monitor results generated from the monitor components (labeled by “monitor”) are independent of each other. FIG. 11 is a diagram illustrating a single-group case according to an embodiment of the present invention, where all monitor components (labeled by “monitor”) and all processing components (labeled by “Comp”) are grouped into a single group A, where a global monitor result is determined by jointly considering monitor results generated from all monitor components in the same group A. FIG. 12 is a diagram illustrating a hybrid case according to an embodiment of the present invention, where some monitor components (labeled by “monitor”) and some processing components (labeled by “Comp”) are grouped into one group A, some monitor components (labeled by “monitor”) and some processing components (labeled by “Comp”) are grouped into another group B, and some monitor components (labeled by “monitor”) and some processing components (labeled by “Comp”) are not grouped into any group. Hence, a global monitor result is determined by jointly considering monitor results generated from all monitor components in the same group A, and another global monitor result is determined by jointly considering monitor results generated from all monitor components in the same group B.

In some embodiments of the present invention, an assignment of monitor components and associated processing components grouped into a same group may be configurable. That is, there are multiple processing components and multiple monitor components included in a data processing system (e.g., image processing system), an assignment of processing components in a same group that are selected from the multiple processing components is configurable, and an assignment of monitor components in a same group that are selected from the multiple monitor components is also configurable. For example, the grouping design shown in FIG. 12 may be adaptively adjusted, where the number of groups is configurable, and the assignment of monitor components (or processing components) to groups is configurable.

In some embodiments of the present invention, an assignment of monitor components and processing components grouped into a same group may be non-configurable. That is, there are multiple processing components and multiple monitor components included in a data processing system (e.g., image processing system), an assignment of processing components in a same group that are selected from the multiple processing components is non-configurable, and an assignment of monitor components in a same group that are selected from the multiple monitor components is non-configurable. For example, the grouping design shown in FIG. 12 may be fixed, where the number of groups is fixed, and the assignment of monitor components (or processing components) to groups is fixed.

In above embodiments shown in FIGS. 2-5, the monitor component may receive a driver setting programming status of the source device and a driver setting programming status of the processing component from the driver setting programmers (e.g., software drivers or hardware drivers). However, this is for illustrative purposes only, and is not meant to be a limitation of the present invention. In some embodiments, the monitor component may be configured to directly monitor a driver setting programming status of the source device and a driver setting programming status of the processing component.

In some embodiments of the present invention, the processing component may change its driver settings during each period. Hence, after a start time of each period (e.g., a streaming start time of each image frame), the monitor result generated from a corresponding monitor component is set to indicate that driver settings are not ready. The monitor result generated from the corresponding monitor component is not set to indicate that driver settings are ready until programming of new driver settings is done.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing system comprising:
a source device, configured to generate a streaming output, wherein the streaming output comprises consecutive data segments for each data path, and the consecutive data segments are output during consecutive periods, respectively;
a first processing device, located on at least one data path and configured to receive and process a first streaming input derived from the streaming output; and
a first monitoring circuit, configured to monitor if driver settings of the source device are ready before a start time of a first period included in the consecutive periods, and further monitor if driver settings of the first processing device are ready before the start time of the first period;
wherein when a monitor result generated from the first monitoring circuit indicates that the driver settings of the source device are not ready before the start time of the first period or the driver settings of the first processing device are not ready before the start time of the first period, the first processing device is configured to skip processing of streaming data associated with at least one period starting from the first period.

2. The data processing system of claim 1, wherein the first monitoring circuit is coupled between the source device and the first processing device; and when the monitor result indicates that the driver settings of the source device are not ready before the start time of the first period or the driver settings of the first processing device are not ready before the start time of the first period, the first monitoring circuit is configured to drop a data segment received from the source device during each of the at least one period starting from the first period.

3. The data processing system of claim 1, wherein the first processing device is coupled to the source device without via the first monitoring circuit; and when the monitor result indicates that the driver settings of the source device are not ready before the start time of the first period or the driver settings of the first processing device are not ready before the start time of the first period, the first processing device is configured to drop a data segment received from the source device during each of the at least one period starting from the first period.

4. The data processing system of claim 1, wherein the at least one period comprises the first period only.

5. The data processing system of claim 1, wherein the at least one period comprises the first period and at least one second period following the first period.

6. The data processing system of claim 1, wherein the first monitoring circuit directly monitors a driver setting programming status of at least one of the source device and the first processing device.

7. The data processing system of claim 1, wherein the first monitoring circuit is informed of a driver setting programming status of at least one of the source device and the first processing device.

8. The data processing system of claim 1, wherein the first processing circuit changes its driver settings during each of the consecutive periods; and after a start time of each of the consecutive periods, the monitor result generated from the first monitoring circuit is set to indicate that driver settings are not ready.

9. The data processing system of claim 1, wherein the first processing device comprises only a single processing component located on one data path; and the first monitoring circuit comprises only a single monitor component, where the monitor result is determined by the single monitor component.

10. The data processing system of claim 1, wherein the first processing device comprises a plurality of processing components located on a plurality of data paths, respectively; and the first monitoring circuit comprises only a single monitor component, where the monitor result is determined by the single monitor component.

11. The data processing system of claim 1, wherein the first processing device comprises a plurality of processing components located on a plurality of data paths, respectively; and the first monitoring circuit comprises a plurality of monitor components corresponding to the plurality of processing components, respectively, where the monitor result is jointly determined by the plurality of monitor components.

12. The data processing system of claim 11, wherein there are multiple processing components and multiple monitor components included in the data processing system; an assignment of the plurality of processing components that are selected from the multiple processing components is configurable, and an assignment of the plurality of monitor components that are selected from the multiple monitor components is configurable.

13. The data processing system of claim 11, wherein there are multiple processing components and multiple monitor components included in the data processing system; an assignment of the plurality of processing components that are selected from the multiple processing components is non-configurable, and an assignment of the plurality of monitor components that are selected from the multiple monitor components is non-configurable.

14. The data processing system of claim 1, further comprising:
a second processing device, located on at least one data path and configured to receive and process a second streaming input derived from the streaming output; and
a second monitoring circuit, configured to monitor if driver settings of the source device are ready before the start time of the first period, and further monitor if driver settings of the second processing device are ready before the start time of the first period;
wherein when a monitor result generated from the second monitoring circuit indicates that the driver settings of the source device are not ready before the start time of the first period or the driver settings of the second processing device are not ready before the start time of the first period, the second processing device is configured to skip processing of streaming data associated with at least one period starting from the first period.

15. The data processing system of claim 1, wherein the source device comprises at least one image sensor.

16. The data processing system of claim 1, wherein the first processing device comprises at least one image signal processing pipeline component.

17. The data processing system of claim 1, wherein the consecutive data segments are consecutive image frames.

18. A data processing method comprising:
generating, by a source device, a streaming output that comprises consecutive data segments for each data path, wherein the consecutive data segments are output during consecutive periods, respectively;
receiving and processing, by a first processing device located on at least one data path, a first streaming input that is derived from the streaming output;
monitoring if driver settings of the source device are ready before a start time of a first period included in the consecutive periods;
monitoring if driver settings of the first processing device are ready before the start time of the first period; and
in response to a monitor result indicating that the driver settings of the source device are not ready before the start time of the first period or the driver settings of the first processing device are not ready before the start time of the first period, skipping processing of streaming data associated with at least one period starting from the first period.

19. The data processing method of claim 18, wherein skipping processing of streaming data associated with the at least one period starting from the first period comprises:
during each of the at least one period starting from the first period, blocking a data segment from being received by the first processing device.

20. The data processing method of claim 18, wherein skipping processing of streaming data associated with the at least one period starting from the first period comprises:
dropping, by the first processing device, a data segment received during each of the at least one period starting from the first period.
